(19) United States
(12) Patent Application Publication
(10) Pub. No.: US 2006/0155850 A1
(43) Pub. Date: Jul. 13, 2006

(54) Networked mobile EPG service architecture

(75) Inventors: Yue Ma, West Windsor, NJ (US); Jinhong Guo, West Windsor, NJ (US); Dennis Bushmitch, Somerset, NJ (US); Guiran Chang, Shenyang City (CN); Jingbo Zhu, Shenyang City (CN); Chuan Zhu, Shenyang City (CN)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/285,622

(22) Filed: Nov. 22, 2005

Related U.S. Application Data
(63) Continuation-in-part of application No. 10/894,469, filed on Jul. 19, 2004.
(60) Provisional application No. 60/524,599, filed on Nov. 25, 2003.

(51) Int. Cl. G06F 15/173

(52) U.S. Cl. 709/226

(57) ABSTRACT

A networked mobile EPG system includes an EPG application running on a user device to query and retrieve EPG contents from a home network. A home network gateway uses SIP messaging to allow communication of commands and data on the user device to and from a home networked device through bridging between SIP and a non-SIP protocol of the home network. An EPG service on the home network sends EPG metadata when a query is made from the user device.

### CROSS-REFERENCE TO RELATED APPLICATIONS

This application is a continuation-in-part of U.S. patent application Ser. No. 10/894,469 filed on Jul. 19, 2004, which claims the benefit of U.S. Provisional Application No. 60/524,599, filed on Nov. 25, 2003. The disclosures of the above applications are incorporated herein by reference in their entirety for any purpose.

### FIELD OF THE INVENTION

The present invention generally relates to electronic programming guides, and relates in particular to a networked mobile EPG service.

### BACKGROUND OF THE INVENTION

Among home entertainment services, EPG (Electronic Programming Guide) is perhaps the most appealing applications for television, and its services continue to grow in the emergence of new digital TV market. Traditionally, for both analog and digital interactive TV, EPG applications are running on the set-top box and its services are provided by the MSO (e.g., cable provider) for a fee. Additional features associated with EPG application on a STB are content filtering and program recommendation, among others.

As the convergence of mobile and home devices evolves in the new digital networking era, there is a need for mobile devices to receive the similar services as offered on a home networked device. Consequently, EPG on mobile draws much attention. Naturally, this service is offered by the cell phone providers or Internet portal provider (WAP), both for a fee. Such services require frequent update of EPG content.

Available EPG services for STB and mobile both require customer to pay a subscription fee. Further, they use proprietary technologies. As a result, users must pay for provision of both services if they want the EPG to be provided in their homes and also on their mobile devices. Accordingly, there is a need for realizing an EPG service on a home network that is exportable to mobile devices.

### SUMMARY OF THE INVENTION

In accordance with the present invention, a networked mobile EPG system includes an EPG application running on a user device to query and retrieve EPG contents from a home network. A home network gateway uses SIP messaging to allow communication of commands and data on the user device to and from a home networked device through bridging between SIP and a non-SIP protocol of the home network. An EPG service on the home network sends EPG metadata when a query is made from the user device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a mobile EPG system architecture in accordance with the present invention;

FIG. 2 is a block diagram of a SIP Stack implemented in a home network gateway in accordance with the present invention;

FIG. 3 is a block diagram illustrating a SIP Service for a home network gateway in accordance with the present invention;

FIGS. 4a and 4b are views of EPG user interface components for browsing at various levels of detail in accordance with the present invention;

FIG. 5 is a view of an EPG user interface component outputting EPG recommendations in accordance with the present invention;

FIG. 6 is a block diagram illustrating an EPG software engine in accordance with the present invention;

FIG. 7 is a block diagram illustrating a mobile EPG application and SIP middleware architecture in accordance with the present invention;

FIG. 8 is a flow diagram illustrating SIP signaling in accordance with the present invention; and

FIG. 9 is a block diagram illustrating an EPG bundle and SIP bridging in accordance with the present invention.

### DETAILED DESCRIPTION OF THE PREFERRED EMBODIMENTS

The following description of the preferred embodiments is merely exemplary in nature and is in no way intended to limit the invention, its application, or uses.

The mobile EPG system according to the present invention has a system architecture based on SIP (Session Initiation Protocol) and a home network protocol (e.g., OSGi (Open Service Gateway Initiative)) to realize an EPG service on a home network and export such service to a remote mobile device via SIP. The use of SIP simplifies the communication protocol (in comparison to, for example, http) for a mobile device to receive data, and the use of an OSGi gateway or equivalent allows multiple vendors to develop EPG service applications for the home.

The mobile EPG system according to the present invention can have applications and features that operate according to one or more of the following assumptions: (1) an EPG database is downloaded to home network device (e.g. home server) in some way, for example, through STB broadcast, Internet etc.; (2) an EPG service is running on a home server to analyze EPG contents in the EPG database and provide filtering and recommendation services; and (3) the EPG service can be accessed and configured from a mobile device in a remote location.

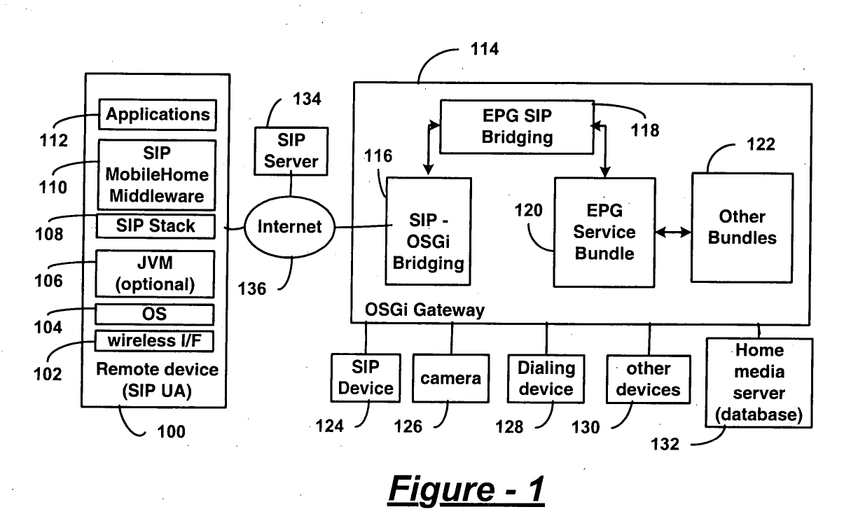

In accordance with some embodiments of the system architecture, the system can be comprised of mainly two parts: mobile device and home network. The architecture of the system can be based on SIP-OSGi bridging. Referring to FIG. 1, a mobile device 100 can include an operating system 104, a Java virtual machine (JVM) 106, applications 112 with GUI, SIP middleware 110, network stack (SIP) 108, and wireless interface 102. The mobile device can communicate with a home network via SIP protocol. Therefore, the mobile device can also act as a SIP UA (user agent) from the SIP network perspective.

The mobile applications can realize one or more of the scenarios described previously. The application can communicate with the home entertainment network and be able to download information from entertainment devices, utilize related services (e.g. EPG service), and control these devices. The SIP stack enables the mobile device with SIP. Depending on SIP implementation, a JVM may or may not be required.

SIP was originally designed as the protocol for multimedia session creation and termination with its intended use in Voice over IP. To use SIP in home networking applications, a middleware is needed to convert SIP signaling protocols to home networking specific functions. In some embodiments, the middleware can be an internal library that receives messages from mobile applications in relation to home entertainment, and convert them to SIP commands. It can also receive SIP messages and events and send relevant messages to applications.

The purpose of building SIP middleware is two fold. One is to simplify SIP signaling protocols for applications and this middleware is to be able to re-use for future applications. The second purpose is to make the mobile application independent of SIP, therefore providing flexibility to use other than SIP protocols in the future, if needed. For example, if the mobile device is equipped with an OSGi framework for mobile environments in the future, SIP middleware needs to be replaced, but mobile applications do not need to be rewritten.

SIP Server 134 is an intermediary device that is located within the SIP-enabled network 136 and assists user agents in session establishment and other functions. It is a general term for SIP Proxy, redirect server, or registrar server.

OSGi Gateway 114 provides a basic framework for networked devices 124-132 to be able to communicate and control each other. OSGi supports a variety of networks such as UPnP, Jini, Http etc.

The SIP-OSGi bridging 116 is an adaptor to allow devices and services (applications) on the OSGi gateway to possess SIP capability that allows them to be able to communicate with other SIP devices in a remote location via SIP server/proxy. EPG-SIP bridging 118 can interface an EPG service bundle 120 and other bundles 122 with SIP-OSGI bridging. SIP-OSGi bridging can be constructed in two ways.

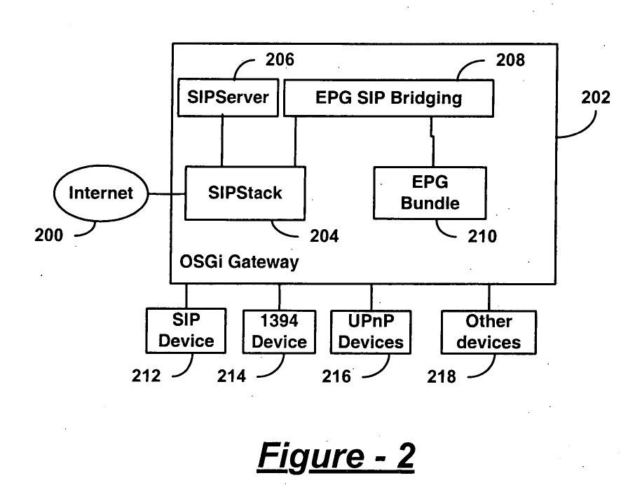

A first way in which SIP-OSGI bridging can be constructed is referred to herein as SIP Stack Bundle on OSGi. Turning now to FIG. 2, a SIP stack 204 can be retrofitted to the OSGi gateway 200 with a SIP server 206. It is, therefore, accessible by other OSGi applications (bundles), such as EPG bundle 210, through standard SIP signaling protocol. EPG bridging 208 can interface EPG bundle 210 with the SIP stack 204, while SIP stack 204 interfaces SIP, 1394, UPnP, and other devices 212-218 with a SIP enable network 200.

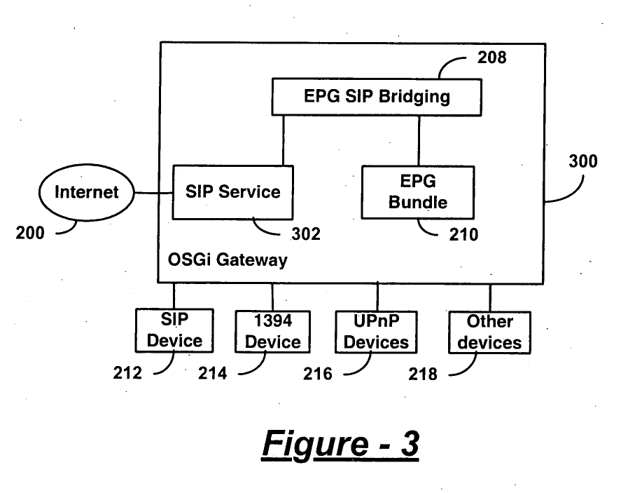

A second way in which SIP-OSGI bridging can be constructed is referred to herein as SIP Service for OSGi. As illustrated in FIG. 3, an OSGi package (bundle)—SIP Service 302, is designed to handle mobility and inter-gateway bridging of OSGi devices, such as SIP, 1394, UPnP, and other devices 212-218. Details relating to the SIP service 302 can be found in the present application's parent U.S. patent application Ser. No. 10/894,469 filed on Jul. 19, 2004, herein incorporated by reference in its entirety for any purpose. SIP service 302 is installed on Gateway 300 and interfaced with network 200, and EPG-SIP bridging 208, which still connects to EPG bundle 210. SIP Service 302 provides the following functionalities, presently absent in OSGi framework, through its own SIP Service API: (1) WAN communication of SIP devices, in which case SIP protocol enables secure communication between the wide area mobile device and local devices and services that are connected and registered with OSGi home gateway; (2) OSGi device and service application-layer mobility, in which case, selected OSGi devices/services can be exported as a SIP device and registered with SIP proxy/location service, and this device then gains the mobility feature of SIP, being able to move and register with another SIP server; (3) OSGi inter-gateway bridging, in which case, devices registered with one OSGi framework's registry are exported by bridging bundles as SIP devices and imported into a service registry of another OSGi framework as SIP devices, thus allowing one OSGi device on one network to be treated as a local device on another network.

The SIP-OSGi bridging allows sharing and control of these devices from outside the home via SIP service. Services can also be installed and executed on the framework. For example, EPG service can be installed on the OSGi framework and utilized by devices or other bundle services on the network.

EPG service provides information to requested devices about TV programming. It can also be configured to only provide EPG in selected categories, or adaptively filter, prioritize and recommend EPG based upon user's preference. The source of EPG can be diverse: local media, Internet, or digital TV broadcast (via STB). The policy of EPG recommendation can be implemented differently without changing the EPG Service bundle API.

The SIP Bridging for EPG service is provided within the gateway SIP middleware to allow other SIP devices to access such service through SIP-OSGi bridging. It converts EPG requests/events to SIP methods and events, which is necessary for SIP devices to access the functions of EPG service bundle.

SIP Device bridging provides capabilities for EPG service to be able to control other OSGi or non-OSGi devices. For example, a SIP-UPnP bridging may convert SIP commands/messages/events to those of UPnP and therefore allows EPG service to control an UPnP device on OSGi framework.

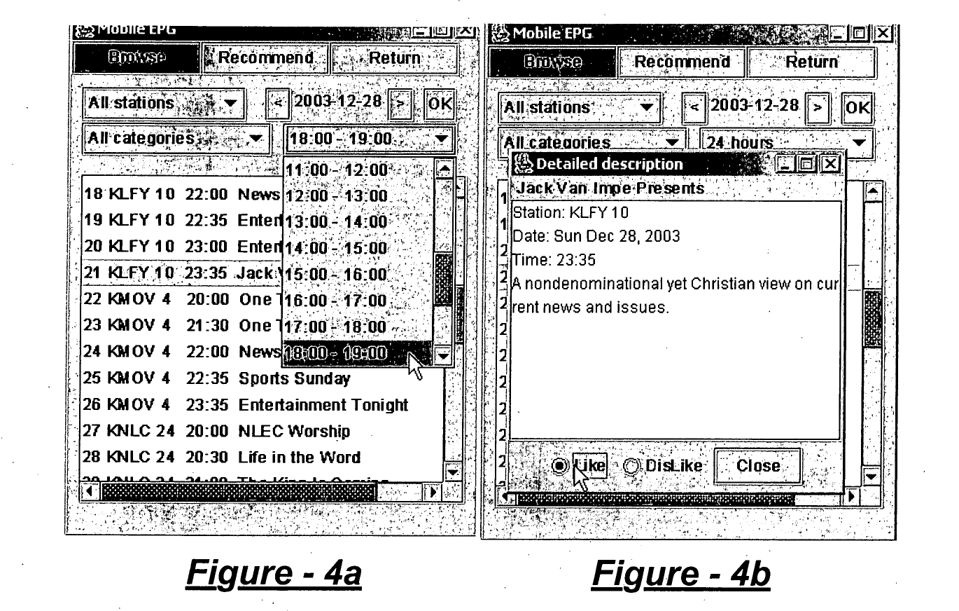

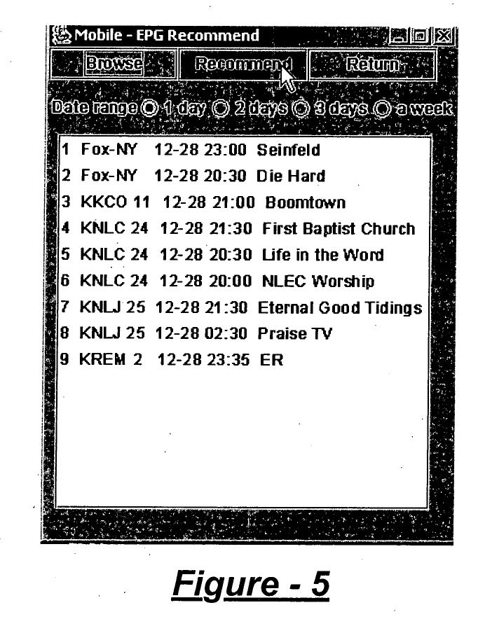

The mobile EPG application remotely accesses and controls home network devices. In some embodiments, an EPG service is installed on the home network to provide EPG services. The service can function as follows: (1) the mobile device registers with home network and request selected EPG information; (2) the user is able to browse EPG information in different levels of detail as shown in FIG. 4; (3) the mobile application on the remote device receives filtered and prioritized EPG information from home network, and displays in a GUI as shown in FIG. 5; (4) the user selects a program of interest from the EPG and selects to record; (5) a record command is sent off to a home networked PVR device to record the selected show.

As previously stated, SIP middleware is needed in order to convert SIP signaling protocols to home network flavor functions, and vice versa. Particularly, for home networking applications, several basic functions are needed: (1) register a mobile device with home network; (2) list the devices, services and events available on the home network; (3) subscribe to events on the home network, such as system events (e.g., new devices are added to the home network) and special events that are provided by devices or services on the network (e.g., reminder of a TV show); (4) send control commands to a device on the home network, such as “record” on a PVR; (5) request and receive data from home network devices or services (e.g., EPG data from home media server or EPG service, shopping list data from networked refrigerator, etc.); (6) start and terminate audio/video streaming session with an A/V device on the home network, such as connect to a SIP phone at home, or view video stream that is being captured from a security camera.

The SIP protocol provides capability of device/service discovery, control, registration and events through methods like REGISTER, MESSAGE, and SUBSCRIBE.

Both data and media stream need to be “carried” via SIP service. The challenge is that SIP can only carry a small message body, not suitable for a large chunk of data or streams of video. Therefore, the transport of data can be implemented in the following ways: (1) short messages such as request and control commands can be carried in SIP MESSAGE body as plain text, and these messages can be transparent to proxies and need to be interpreted at the SIP end point; (2) additional information such as a chunk of data can be added and carried in a separate message body attachment as a payload, and it can be either text based or MIME type; (3) RTP can be used for media transport, with the multimedia streaming session being negotiated by applications in SDP (session description protocol), which is a simple text based protocol that is supported by SIP and completely transparent to SIP.

Home EPG application service bundles are collections of application specific services that are packaged into OSGi bundles to be executed within the OSGi framework from any requested devices/services. The EPG service provides EPG contents to requested device. The EPG contents include different levels of detail (e.g., program title, synopsis, detailed program information, photo, preview video clip, etc.) for optimizing on the application device display.

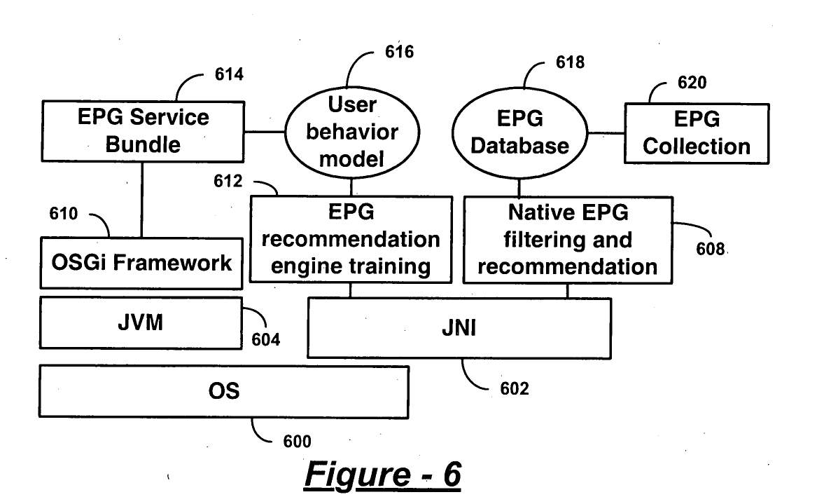

Referring to FIG. 6, the architecture of the EPG service includes the following components: (1) a repository 618 and management for EPG contents; (2) a simple retrieval tool with keyword search; (3) optionally, a built-in filtering and recommendation engine 608; and (4) optionally, an automatic EPG update mechanism 620 from either TV broadcast or Internet. An EPG service bundle 614 running on the OSGI framework 610 can obtain and/or employ a user behavior model 616 using an EPG recommendation training engine 612. These software can run on a basic platform including an operating system 600, JVM 604, and/or JNI 602.

Again, a SIP bridging is needed in order for EPG service to be accessed by mobile device via SIP service. The SIP bridging for EPG service can function as follows: (1) register with OSGi SIP Service and act itself as an EPG SIP UA; (2) pass SIP commands to/from EPG service bundle; and (3) pass data to/from EPG service bundle through SIP messages or MIME type payloads.

Mobile applications run on the mobile device and directly interact with end users via GUI. The applications take user's input from applications and translate to mobile-home middleware “protocols”. Applications also receive the results from middleware and display to the user via GUI. The following describes an example of translation between GUI functions and mobile-home middleware modules.

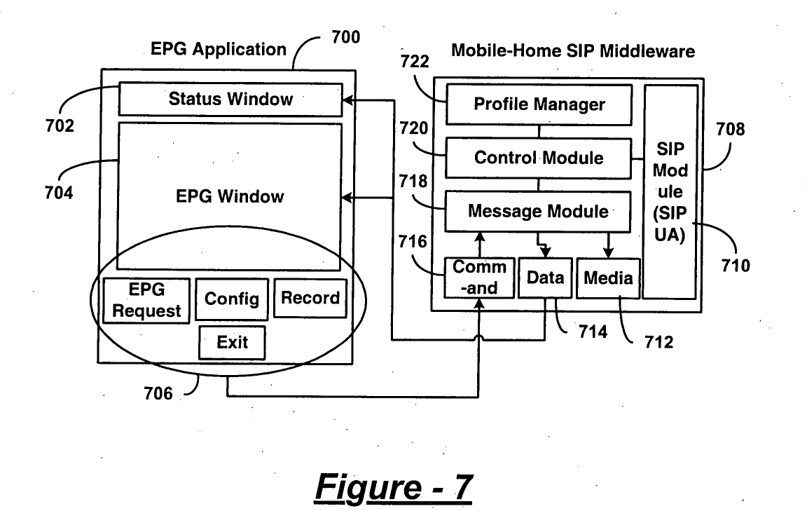

Turning now to FIG. 7, the detailed structure of the mobile EPG application 700 and mobile-home SIP middleware 708 architecture is provided. Commands 716 from user interface input components 706 of the application (such as request EPG, control device to record, etc.) are received by message module 718 and converted to a SIP message body by control module 720. The EPG data 714, or other short messages 712 are carried in SIP message body and interpreted by control module, which then pass to the application through message module for display via user interface output components 702 and 704. SIP module 710 is the SIP entity representing the EPG SIP middleware in the SIP network.

EPG data can be filtered depending on personal preferences. These preferences can be defined manually by the application (“Config” button) or collected automatically on the device by monitoring user's interaction with EPG data. These preferences can be locally stored on the Profile Manager 722 and be utilized by Control module when it packs an EPG request into a SIP message body.

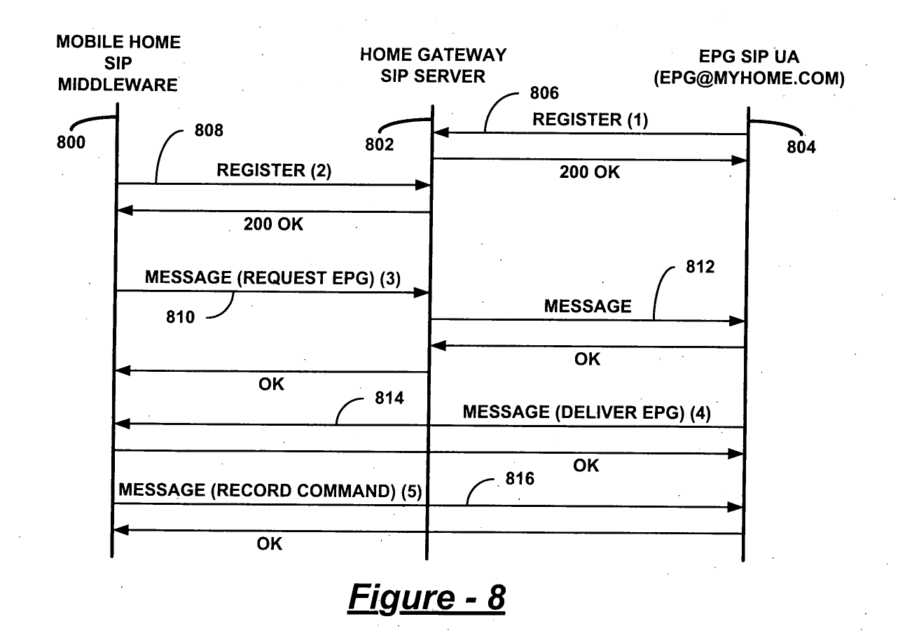

Turning now to FIG. 8, SIP methods to send commands or receive data to and from a server 802 can be employed. Basically the mobile-home SIP middleware SIP UA 800 needs to register with the SIP service on the home gateway in order to request any data from other services (as virtual SIP UA) on the home gateway. For example, the Home EPG SIP UA 804 registers itself with the Home Gateway SIP Server 802 (SIP Service on OSGi) and becomes a virtual SIP UA at 806. By registering with SIP Service, it is also registered with OSGi framework. Therefore, the EPG SIP UA 804 has both SIP capability and access to other OSGi bundles on the framework. In an additional or alternative embodiment, mobile-home SIP middleware 800 registers to SIP server 802 at 808 and makes its SIP URL available to the server. Consider the following example message using UDP (user datagram protocol) as transport layer IP protocol to carry SIP messages.

REGISTER sip:sipserver.myhome.com SIP/2.0

Via SIP/2.0/UDP 4.3.2.1:5060

To: Matthew Ma <sip:mma@mymobile.com>

From: Matthew Ma <sip:mma@mymobile.com>

Contact: <sip:mma@4.3.2.1>; class=personal

. . .

Upon receipt from SIP server:

SIP/2.0 200 OK

Via: SIP/2.0/UDP 4.3.2.1:5060

To: Matthew Ma <sip:mma@mymobile.com>

From: Matthew Ma <sip:mma@mymobile.com>

Contact: <sip:mma@4.3.2.1>; class=personal; expires=3600

Notice that the 200 OK response to a REGISTER echoes the contact URL that have been successfully registered.

In another additional or alternative embodiment, mobile-home SIP middleware sends an instant messaging message to the Home EPG SIP UA 804 via SIP server 802 requesting EPG as at 810 and 812. Consider the following example message:

MESSAGE im:epg@myhome.com SIP/2.0

Via: SIP/2.0 UDP 4.3.2.1

To: Home EPG <im:epg@myhome.com>

From: Matthew Ma <im:mma@mymobile.com>

Cseq: 1 MESSAGE

<EPG REQUEST XML BODY>

In still another additional or alternative embodiment, Home EPG SIP UA 804 delivers requested EPG through SIP message body as at 814. A sample messages looks like:

MESSAGE im:mma@mymobile.com SIP/2.0

Via: SIP/2.0/UDP 198.162.1.100:5060

To: Matthew Ma <im:mma@mymobile.com>

From: Home EPG <im:epg@myhome.com>

Cseq: 1 MESSAGE

<EPG data XML body>

In yet another additional or alternative embodiment, Mobile-Home SIP middleware 800 acts upon EPG and decides to record a show of interest. A “record” command is sent as at 816 via IM message like:

MESSAGE im:epg@myhome.com SIP/2.0

Via: SIP/2.0/UDP 4.3.2.1:5060

To: Home EPG <im:epg@myhome.com>

From: Matthew Ma <im:mma@mymobile.com>

Contact: <sip:mma@4.3.2.1>

Cseq: 1 MESSAGE

<Device control record XML body>

Some example Java Objects for Mobile Home SIP Middleware in FIG. 7 are provided below in pseudocode.
class UAConfig
{

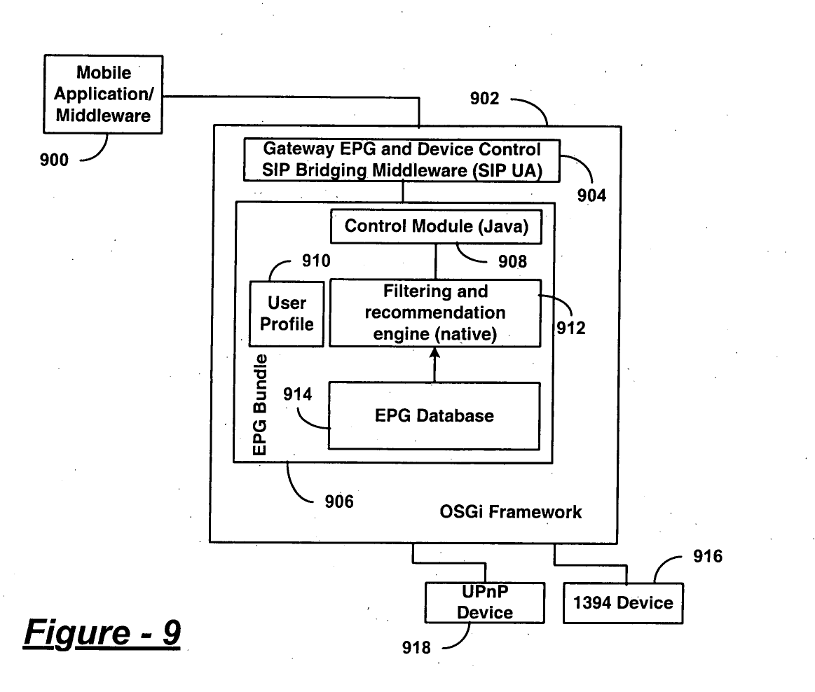

Turning now to FIG. 9, details of an EPG bundle 906 for use with an OSGi Gateway framework 902 and SIP Bridging are provided. Framework 902 connects to mobile application/middleware 900. EPG Bundle 906 provides selected EPG data upon request. It includes an EPG database 914. EPG data can come from various sources such as broadcast (OCAP in digital, or VBI for analog), Internet, or external peripherals such as media cards. In some embodiments, a mechanism to acquire and update EPG contents can be included.

The control module 908 of EPG handles all EPG requests and returning of requested EPG data. In most cases, transmitting the entire EPG contents for all TV stations may not be feasible due to limited capabilities (storage, memory, network latency etc) such as a mobile device. Therefore, a filtering and recommendation engine 912 is needed to send selected EPG data. A user can include keywords/qualifiers in their EPG request to specify what kind of contents to request.

Optionally, a user profile 910 can be used to filter or recommend the most appropriate EPG data according to the user's behavior. A user who requests EPG data can also send an updated user profile to override an existing profile, or update only certain fields from an existing user profile. Upon receiving and browsing EPG data, a user can select certain programs to watch or record, and this data can be sent to EPG bundle to heuristically filter and recommend for future request. This feedback process is also called accumulative learning.

EPG SIP bridging middleware 904 acts as an activator of EPG bundle for SIP. This SIP bridging itself can be an OSGi bundle. Upon start, SIP bridging registers to the SIP service (proxy) on OSGi gateway and become a SIP UA. By way of SIP service registration, it is automatically registered to the OSGi framework, which allows it to gain access to other OSGi bundles including EPG Bundle. Since it becomes a SIP UA, it is accessible by other SIP UAs including mobile device on the SIP network. Subsequent SIP communication between mobile device and EPG SIP bridging middleware can be used to send/receive data and commands from mobile device to EPG service. SIP commands from a mobile device are translated so appropriate EPG bundle control functions can be called. Similarly, any status/data from EPG bundle control module are packed into appropriate SIP messages and send to the mobile device

EPG and Device SIP bridging middleware 904 also provides functions for user to control home entertainment devices 918 through SIP protocol. These entertainment devices are on the home network and supported by OSGi framework such as UPnP, Jini. For devices 916 that are not supported by OSGi framework such as 1394, a 1394 control bundle is needed in order to control such a device from OSGi.

Some example Java Objects for EPG Service and SIP Bridging are illustrated below in pseudocode.

class UAConfig
{
//void setConfigFilePath (String configFilePath);
//String getConfigFilePath ( );
void setOutBoundProxyIP( String outBoundProxyIP );
String getOutBoundProxyIP( );
void setOutBoundProxyPort( int outBoundProxyPort );
int getOutBoundProxyPort( );
void setRegistrarIP( String registrarIP );
String getRegistrarIP( );
void setRegistrarPort( int outRegistrarPort );
int getRegistrarPort( );
void setContactIP( String contactIP );
String getContactIP( );
void setContactPort( int contactPort );
int getContactPort( );
void setContactTransport( String Transport );
String getContactTransport( );
void setContactURI ( String mobileURI );
String getContactURI ( );
}
class Buddy
{
void setBuddySIPServiceID(String ID);
String getBuddySIPServiceID( );
void setBuddyURI(String buddyURI);
String getBuddyURI( );
void setBuddyAppName(String buddyAppName);
String getBuddyAppName( );
void setBuddyAppType(String buddyAppType);
String getBuddyAppType( );
/**
**Matrix of BuddyServiceList:
*first dimension is for { subscribe, invite, etc}
*second dimension is description of service
*/
String [ ][ ] getBuddyServiceList( );
void setBuddyServiceList(String [ ][ ] buddyServiceList);
}
class BuddyList
{
Vector getBuddyList(String SIPServiceID);
Vector getBuddyList(String SIPServiceID, String buddyAppType);
Buddy getBuddy(String buddyURI);
void addBuddy(Buddy buddy);
String [ ] getBuddyTypeList(String SIPServiceID);
}
/** EPG SIP middleware is handled by CommandSet and DataSet. */
interface Command{
boolean register( String SIPServiceID );
boolean unregister( String SIPServiceID );
}
class CommandSet implements Command{
/**
*Description:
*Register or unregister with SIP server
*Reference:
*SIPServiceID:specified SIP server proxy.
*/
/**
*SIPBridge Usage Example:
*When SIP Bridging starts on the OSGi Home-Network, it will invoke one
registerd
*service of corresponding Application Bundle on Framework. If the
service is available,
*SIP Bridging will invoke register( ) method. On the other hand, SIP
Bridging
*registers unregister( ) method on the Framework for corresponding
Application
*Bundle, which allows the Application Bundle stop on Framework after its
necessarily
*unregistered.
*/
boolean register( String SIPServiceID );
boolean unregister( String SIPServiceID );
/**
*Description:
*Send notify to mobile application, which is generated by the services
subscribed
*by the mobile.
*Reference:
*appName: application name on the mobile.
*typeOfEvent: event to be notified.
*XMLData: description of notify.
*/
/**
*Usage Example:
*Currently, this method is not used for EPG middleware.
*/
boolean notify(String appName, String typeOfEvent, String XMLData);
}
class DataSet {
/**
*Description:
*Send XML data to specified application on mobile.
*Reference:
*appName: mobile.
*XMLData: XML data
*/
synchronized boolean sendMessage(String appName, String XMLData);
/**
*Description:
*Pass XML data, which is received from mobile, to application on
*Home-Network.
*Reference:
*buddyURI:mobile.
*XMLData: XML data.
*/
void receiveMessage(String buddyURI, String XMLData);
}

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A networked mobile EPG system, comprising:
an EPG application running on a user device to query and retrieve EPG contents from a home network;
a home network gateway using SIP messaging to allow communication of commands and data on the user device to and from a home networked device through bridging between SIP and a non-SIP protocol of the home network; and
an EPG service on the home network to send EPG metadata when a query is made from the user device.

2. The system of claim 1, wherein said EPG service is further adapted to filter the EPG metadata when based on the query.

3. The system of claim 1, wherein said EPG service is further adapted to recommend the EPG metadata based on the query.

4. The system of claim 1, wherein an EPG database is downloaded to a device of the home network, said EPG service is running on the home network to analyze EPG contents in the EPG database and provide filtering and recommendation services, and said EPG service can be accessed and configured from the portable device in a remote location.

5. The system of claim 1, wherein the portable device includes applications with GUI, a wireless interface, middleware, and a network stack enabling the device to communicate with the home network via SIP protocol, therefore acting as a SIP UA (user agent) from the SIP network perspective.

6. The system of claim 1, wherein said home network gateway includes a set of middleware to convert SIP signaling protocols to one or more gateway-specific self-described services.

7. The system of claim 6, wherein the set of middleware has logic to:
convert messages from the one or more services in relation to home entertainment to SIP commands, and
receive SIP messages and events and send relevant messages to the EPG application.

8. The system of claim 1, further comprising a SIP server that is an intermediary device located within a SIP-enabled network connecting the portable device and the home network and assisting user agents, including the portable device, in session establishment and other functions.
The system of claim 1, wherein said home network gateway provides a basic framework for networked devices to be able to communicate and control each other.

9. The system of claim 1, wherein said home network gateway includes a bridging module that serves as an adaptor to allow devices and services (applications) on the home network gateway to possess SIP capability that allows them to communicate with other SIP devices in a remote location via a SIP server/proxy.

10. The system of claim 9, wherein the bridging module includes a SIP stack retrofitted to said home network gateway.

11. The system of claim 9, wherein the bridging module takes the form of a SIP service designed to handle mobility and inter-gateway bridging of devices operating according to a non-SIP service discovery protocol, the service providing WAN communication of SIP Devices; device and service application-layer mobility, and inter-gateway bridging.

12. The system of claim 1, wherein said EPG service is configured to only provide EPG metadata in selected categories.

13. The system of claim 1, wherein said EPG service is configured to adaptively filter, prioritize, and recommend EPG metadata based upon user preference.

14. The system of claim 13, wherein a policy of EPG recommendation can be implemented differently without changing an EPG Service bundle API of the system.

15. The system of claim 1, wherein SIP bridging for said EPG service is provided within SIP middleware of said home network gateway to allow other SIP devices to access said EPG service by converting EPG requests/events to SIP methods and events.

16. The system of claim 1, wherein SIP device bridging provides capabilities for said EPG service to be able to control devices operating according to the non-SIP service discovery protocol of the home network, and still another non-SIP service discovery protocol of another device by converting SIP commands/messages/events to those of the still other non-SIP protocol, therefore allowing said EPG service to control the other device on a framework of the home network.

17. The system of claim 1, wherein said EPG service provides universal API to gateway devices and services.

18. The system of claim 1, wherein said EPG service is discoverable via a service registry of the gateway.

19. The system of claim 1, wherein said EPG service is adapted to interact with multiple bundles.

20. A portable device for use with a networked mobile EPG system, the device comprising:
one or more applications with graphical user interface components adapted to send EPG requests to a home network via SIP and display EPG contents received form the home network via SIP;
a wireless interface for communicating with a SIP enabled network; and
a network stack enabling said device to communicate with the home network via SIP protocol, therefore acting as a SIP UA (user agent) from the SIP network perspective.

21. The device of claim 20, wherein one or more of said application is adapted to communicate with the home entertainment network and download information from entertainment devices connected to the home network, utilize related services, and control the devices.

22. The device of claim 20, further comprising SIP middleware at least one of converting SIP signaling protocols to home networking specific functions or receiving SIP messages and events and sending relevant messages to one or more of said applications.

23. The device of claim 22, wherein said middleware receives messages from one or more of said applications in relation to home entertainment, and converts them to SIP commands for transmission over said SIP enabled network.

24. The device of claim 22, wherein said middleware includes an API and process logic to perform functions for other applications.

25. The device of claim 22, wherein said middleware is adapted to receive SIP messages and events from said SIP enabled network and send relevant messages to one or more of said applications.

26. A home network for use with a mobile EPG system, the network comprising:
a home network gateway using SIP messaging to allow communication of commands and data on a user device to and from a home networked device through bridging between SIP and a non-SIP protocol of the home network; and
an EPG service on the home network to send EPG metadata when a query is made from the user device.

27. The network of claim 26, wherein said EPG service is further adapted to filter the EPG metadata based on the query.

28. The network of claim 26, wherein said EPG service is further adapted to recommend the EPG metadata based on the query.

29. The network of claim 26, wherein an EPG database is downloaded to a device of the home network, said EPG service is running on the home network to analyze EPG contents in the EPG database and provide filtering and recommendation services, and said EPG service can be accessed and configured from the portable device in a remote location.

30. The network of claim 26, wherein said home network gateway includes a middleware to convert SIP signaling protocols to home networking specific functions.

31. The network of claim 30, wherein the middleware receives messages from said EPG application in relation to home entertainment, and converts them to SIP commands, and also receives SIP messages and events and sends relevant messages to the mobile application.

32. The network of claim 26, further comprising a SIP server that is an intermediary device located within a SIP-enabled network connecting the portable device and the home network and assisting user agents, including the portable device, in session establishment and other functions.

33. The network of claim 26, wherein said home network gateway provides a basic framework for networked devices to be able to communicate and control each other.

34. The network of claim 26, wherein said home network gateway includes a bridging module that serves as an adaptor to allow devices and services (applications) on the home network gateway to possess SIP capability that allows them to communicate with other SIP devices in a remote location via a SIP server/proxy.

35. The network of claim 34, wherein the bridging module takes the form of a SIP stack retrofitted to said home network gateway.

36. The network of claim 34, wherein the bridging module takes the form of a SIP service designed to handle mobility and inter-gateway bridging of devices operating according to a non-SIP service discovery protocol, the service providing WAN communication of SIP Devices; device and service application-layer mobility, and inter-gateway bridging.

37. The network of claim 26, wherein SIP bridging for said EPG service is provided within SIP middleware of said home network gateway to allow other SIP devices to access said EPG service by converting EPG requests/events to SIP methods and events.

38. The system of claim 1, wherein SIP device bridging provides capabilities for said EPG service to be able to control devices operating according to the other service discovery protocol of the home network, and still another service discovery protocol of another device by converting SIP commands/messages/events to those of the still other protocol, therefore allowing said EPG service to control the other device on a framework of the home network.
